(19) United States
(12) Patent Application Publication
(10) Pub. No.: US 2011/0102730 A1
(43) Pub. Date: May 5, 2011

(54) LIQUID CRYSTAL DEVICE

(75) Inventors: I-Hui Lee, Taipei (TW); Yu-Ching Chao, Taipei (TW); Yu-Chi Chen, Taipei (TW); Liang-Chao Chang, Taipei (TW); Chih-Cheng Hsu, Taipei (TW); Jiunn-Yih Lee, Taipei (TW); Tien-Lung Chiu, Taipei (TW); Jiun-Haw Lee, Taipei (TW)

(73) Assignee: NATIONAL TAIWAN UNIVERSITY, Taipei (TW)

(21) Appl. No.: 12/776,411

(22) Filed: May 9, 2010

(30) Foreign Application Priority Data
Nov. 2, 2009 (TW) 098137078

(51) Int. Cl. C09K 19/02; G02F 1/133

(52) U.S. Cl. 349/175; 349/33

(57) ABSTRACT

The invention provides a liquid crystal device. The liquid crystal device includes a first transparent substrate and a second transparent substrate, wherein the first transparent substrate and the second transparent substrate are parallel to each other. Spacers are formed between the first transparent substrate and the second transparent substrate, to define a cavity; and a cholesteric liquid crystal is disposed into the cavity. Particularly, the liquid crystal device is coupled to a supply voltage, and three states of the liquid crystal device are selectively switched by adjusting the voltage, wherein the three states includes a first transparent state, a scattering state and a second transparent state.

### CROSS REFERENCE TO RELATED APPLICATIONS

This application is based upon and claims the benefit of priority from the prior Taiwan Patent Application No. 098137078, filed on Nov. 2, 2009, the entire contents of which are incorporated herein by reference.

### BACKGROUND OF THE INVENTION

1. Field of the Invention

The invention relates to a liquid crystal device, and more particularly to a liquid crystal device serving as a smart window.

2. Description of the Related Art

Due to global warming, the growth temperature of plants is climbing higher. In order to prevent room temperature from rising, particularly during the summer, air conditioners are used to cool the temperature of a room. According to recent surveys, in several countries, more than half of all electrical usage is allocated for adjusting temperature for human comfort.

Further, shielding, for blocking or reflecting incident light, such as thermal barrier coating or sheathing paper, helps to prevent temperature in buildings or transportation vehicles from rising. However, most shielding, block or reflect both infrared light and visible light, thereby decreasing natural light sources. Moreover, most shielding products for thermal insulation, such as thermal barrier coatings, are non-adjustable. Thus, a shielding effect may not be decreased to increase temperature in buildings or transportation vehicles, unless entirely removed or replaced.

In order to solve the aforementioned problems, the invention provides a liquid crystal device with a thermal insulation function, such as a smart window, which can be controlled to reflect or transmit infrared and visible light by adjusting the supply voltage magnitude. For example, the liquid crystal device may block infrared light, but transmit visible light for natural lighting, or block both infrared and visible light during hot summers. Alternatively, the liquid crystal device may transmit both infrared and visible light to increase temperature in buildings or transportation vehicles during cold winter days.

### BRIEF SUMMARY OF THE INVENTION

An exemplary embodiment of a liquid crystal device includes a first substrate and a second substrate, wherein the first substrate and the second substrate are disposed parallel to each other. A spacer is formed between the first substrate and the second substrate to define a cavity and a cholesteric liquid crystal is disposed in the cavity. The liquid crystal device is coupled to a supply voltage, and the liquid crystal device has a first transparent state, a second transparent state, and a scattering state which are switched by adjusting supply voltage magnitude. The first transparent state means that the liquid crystal device will reflect infrared light, but transmit visible light. The second transparent state means that the liquid crystal device will transmit infrared light and visible light simultaneously. The scattering state means that the liquid crystal device will reflect infrared light and visible light simultaneously.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a cross-section view of a liquid crystal device according to an embodiment of the invention.

FIG. 2 is a flow chart illustrating a method for fabricating a liquid crystal device according to an embodiment of the invention.

FIG. 3 is a schematic diagram of the first transparent state of the liquid crystal device according to an embodiment of the invention.

FIG. 4 is a schematic diagram of the scattering state of the liquid crystal device according to an embodiment of the invention.

FIG. 5 is a schematic diagram of the second transparent state of the liquid crystal device according to an embodiment of the invention.

FIG. 6 is a graph plotting wavelength against transmittance of the liquid crystal devices (A)-(E).

FIG. 7 is a graph plotting wavelength against transmittance of the liquid crystal device (B) when applying various supply voltages.

FIGS. 8a to 8c are photographs showing the liquid crystal device (B) switched to three states respectively.

FIG. 9 is a graph plotting wavelength against transmittance of the liquid crystal device (C) when applying various supply voltages.

FIG. 10 is a graph illustrating the thermal insulating ability of the liquid crystal device (B).

FIG. 11 is a graph illustrating the thermal insulating ability of the liquid crystal device (C).

### DETAILED DESCRIPTION OF THE INVENTION

The invention provides a liquid crystal device, such as a smart window, which may optionally reflect or transmit infrared and/or visible light. By doing so, temperature and natural lighting in buildings or transportation vehicles may be adjusted. Thus, decreasing energy costs and maintenance and operating life span of lighting and cooling devices.

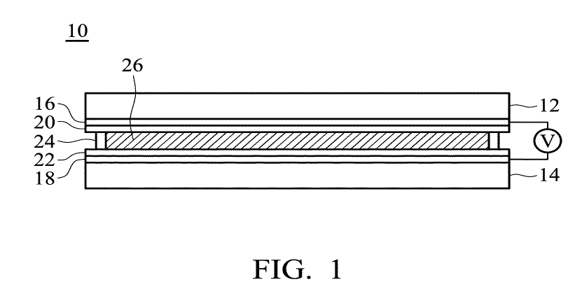

Referring to FIG. 1, the liquid crystal device 10 of the invention includes a first substrate 12 and a second substrate 14, wherein the first substrate 12 and the second substrate 14 can be transparent glass substrate or transparent plastic substrate. The first substrate 12 and the second substrate 14 can respectively have a first transparent electrode 16 and a second transparent electrode 18 formed thereon, wherein the first substrate 12 and the second substrate 14 are disposed parallel to each other, and the first transparent electrode 16 and the second transparent electrode 18 are arranged opposite to each other. Suitable materials of the first transparent electrode 16 and the second transparent electrode 18 can be ITO (indium tin oxide), IZO (indium zinc oxide), AZO (aluminum zinc oxide), ZnO (zinc oxide), SnO₂, or In₂O₃. A first alignment film 20 and a second alignment film 22 can be optionally disposed on the first transparent electrode 16 and the second transparent electrode 18 respectively. The first and second alignment films 20 and 22 can have a pretilt angle and an alignment direction. A plurality of spacers 24 is formed between the first substrate 12 and the second substrate 14 to define a cavity 25. Further, a cholesteric liquid crystal composition 26 is disposed in the cavity 25.

The cholesteric liquid crystal composition 26 of the invention can include a nematic liquid crystal and a chiral compound, wherein the weight ratio between the nematic liquid crystal and the chiral compound is from 8:2 to 7:3. Due to the helical structure of the cholesteric liquid crystal, the cholesteric liquid crystal is known to form a structure that can selectively reflect a certain spectral region.

Cholesteric liquid crystal (CLC) can reflect light through Bragg reflection, because the cholesteric helix is a periodic structure. Light inside the material with wavelength equal to the pitch of the liquid crystal is reflected therefrom, provided it has circular polarization of the same orientation as the helix. By simplifying Bragg's Refraction law, the peak wavelength of selective reflection can be expressed as:

λ=n*p

The wavelength of selective reflection (λ) relates to the average index of refraction of cholesteric liquid crystal (n) and helical pitch (P) of cholesteric liquid crystal.

The liquid crystal molecules are arranged along an alignment film when a device exhibits the first transparent state (stable state).

The liquid crystal molecules are arranged parallel to the electrical field when the electrical field is arranged perpendicular to the cell, and the device exhibits the second transparent state (stable state). Further, some liquid crystal molecules are arranged along the alignment film and others are arranged along the electrical field when the device exhibits the scattering state (unstable intermediate state) between the two transparent states.

The nematic liquid crystal of the invention can include

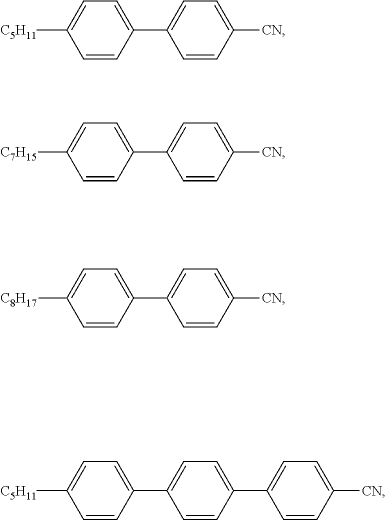

or combinations thereof. The chiral compound of the invention can be

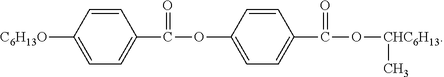

Further, the first transparent electrode 16 and the second transparent electrode 18 of the liquid crystal device 10 can be coupled to a supply voltage V, and the liquid crystal device 10 is switchable to the first transparent state, the second transparent state, or the scattering state by adjusting the supply voltage magnitude V.

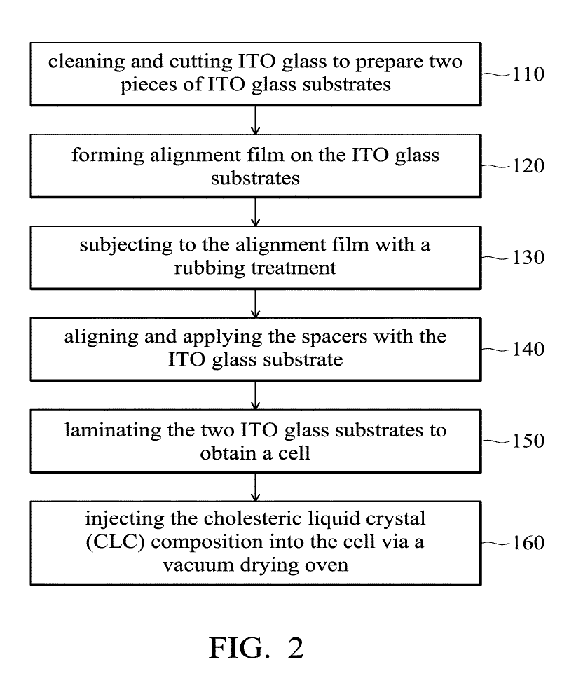

According to an embodiment of the invention, referring to FIG. 2, the method for fabricating the liquid crystal device can include the following steps. A glass with transparent electrode (such as ITO) is provided and then washed by a neutral cleaning agent and an organic solvent with ultrasonic agitation, and the glass with transparent electrode is cut to prepare two glass substrates with transparent electrodes (step 110). Next, alignment films are formed on the transparent electrodes of the two glass substrates respectively (step 120). Next, the alignment films are subjected to a rubbing treatment, resulting in a predetermined pretilt angle and an alignment direction for the alignment films (step 130). Next, spacers are aligned with and located on one glass substrate (step 140). Next, the two glass substrates are laminated by a lamination process after alignment, forming an empty cell (step 150). Finally, the cholesteric liquid crystal composition is injected into the cell by a vacuum drying oven (step 160).

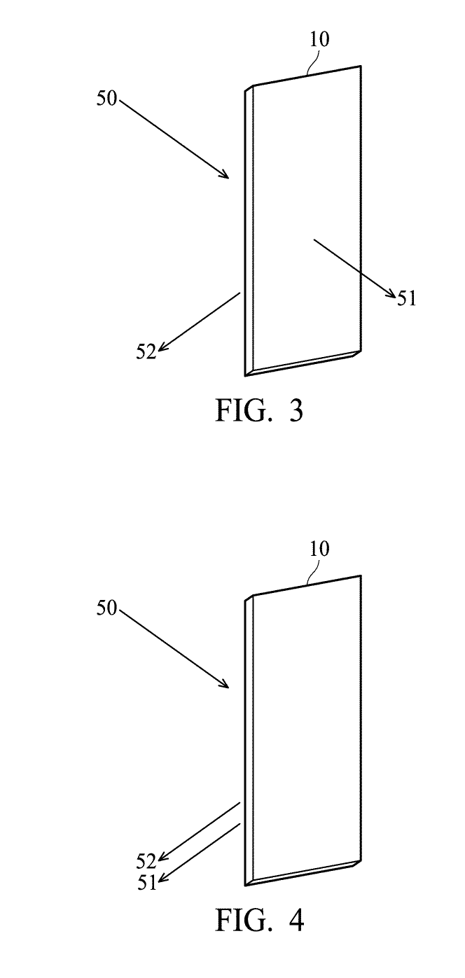

The liquid crystal device of the invention is switchable between three states by adjusting the supply voltage magnitude (or without applying a supply voltage). In an embodiment of the invention, the liquid crystal device is switchable between a first transparent state, a second transparent state, or a scattering state. Referring to FIG. 3, when the supply voltage V holds 0 volts (V=0), the liquid crystal device is switched to the first transparent state (or first stable state), and the cholesteric liquid crystal molecules are arranged along the alignment film. Herein, when the ambient light (sunlight) 50 enters into the liquid crystal device 10 of the invention, the liquid crystal device will reflect infrared light (with a wavelength more than 700 nm) 52 from sunlight, but transmit visible light (with a wavelength of 400-700 nm) 51 from sunlight therethrough.

Therefore, due to thermal insulating property, the liquid crystal device can serve as a smart window for buildings or transportation vehicles and selectively block infrared light and transmit visible light during the summer months, thereby providing illumination and thermal insulation simultaneously.

Referring to FIG. 4, when the supply voltage V reaches a first critical voltage value Va (V=Va), the liquid crystal device is switched to the scattering state (unstable intermediate state). The scattering state is intermediate between the first transparent state and the second transparent state.

In the scattering state, some liquid crystal molecules are arranged along the alignment film and others are arranged along the electrical field (perpendicular to the alignment film). Herein, when the ambient light (sunlight) 50 enters into the liquid crystal device 10 of the invention, the liquid crystal device will reflect infrared light (with a wavelength more than 700 nm) 52 and visible light (with a wavelength of 400-700 nm) 51 from sunlight simultaneously.

Therefore, in comparison with conventional shieldings (such as blinders or curtains), the liquid crystal device can not only block incident visible light to ensure adequate illumination but also block infrared light to maintain a comfortable temperature.

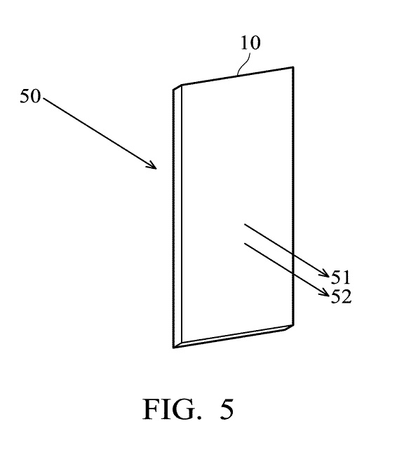

Referring to FIG. 5, when the supply voltage V reaches a second critical voltage value Vb (V=Vb), the liquid crystal device is switched to the second transparent state (second stable state), wherein the second critical voltage is larger than the first critical voltage. In the second transparent state, the liquid crystal molecules are arranged along (parallel to) the electrical field (perpendicular to the alignment film).

Herein, when the ambient light (sunlight) 50 enters into the liquid crystal device 10 of the invention, the liquid crystal device will transmit infrared light (with a wavelength more than 700 nm) 52 from sunlight and visible light (with a wavelength of 400-700 nm) 51 from sunlight therethrough simultaneously.

Therefore, the liquid crystal device of the invention can allow the infrared light and visible light to transmit, thereby reducing electric heating requirements during the winter months.

The following examples are intended to illustrate the invention more fully without limiting their scope, since numerous modifications and variations will be apparent to those skilled in this art.

### Fabrication of Liquid Crystal Device

### Example 1

Alignment films (with a trade No. AL-58 and sold and manufactured by Daily Polymer Corp) were formed on the ITO electrodes of the two ITO glass substrates respectively. Next, the alignment films were subjected to a rubbing treatment, resulting in a predetermined pretilt angle and an alignment direction for the alignment films. Next, spacers (with a thickness of 10 μm) were aligned with and located on one ITO glass substrate. Next, the two ITO glass substrates were laminated by a lamination process after alignment, forming an empty cell. Next, a nematic liquid crystal (with a trade No. E7 and sold and manufactured by Merck, the E7 nematic liquid crystal including

| | |
|---|---|
| 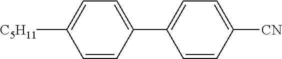 | 51% |
| 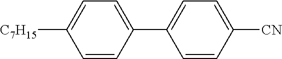 | 25% |
| 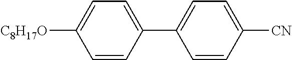 | 16% |
| 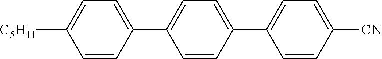 | 8% |

was mixed with a chiral compound (with a trade No. S811 and sold and manufactured by Merck) to prepare a cholesteric liquid crystal composition. Herein, the weight ratio between the nematic liquid crystal E7 and the chiral compound S811 was 9:1, i.e. the nematic liquid crystal was 90 wt %, and the chiral compound was 10 wt %. Next, the cholesteric liquid crystal composition was heated to 55° C. to form a liquid. Finally, the cholesteric liquid crystal composition was injected into the cell by a vacuum drying oven, obtaining a liquid crystal device (A), as shown in Table 1.

### Example 2

The processes for Example 1 were performed for Example 2, with the exception that the weight ratio between the nematic liquid crystal E7 and the chiral compound S811 was modified from 9:1 to 8:2, obtaining a liquid crystal device (B), as shown in Table 1.

### Example 3

The processes for Example 1 were performed for Example 3, with the exception that the weight ratio between the nematic liquid crystal E7 and the chiral compound S811 was modified from 9:1 to 7:3, obtaining a liquid crystal device (C), as shown in Table 1.

### Example 4

The processes for Example 1 were performed for Example 4, with the exception that the weight ratio between the nematic liquid crystal E7 and the chiral compound S811 was modified from 9:1 to 6.5:3.5, obtaining a liquid crystal device (D), as shown in Table 1.

### Example 5

The processes for Example 1 were performed for Example 5, with the exception that the weight ratio between the nematic liquid crystal E7 and the chiral compound S811 was modified from 9:1 to 6:4, obtaining a liquid crystal device (E), as shown in Table 1.

TABLE 1

| Example No. | liquid crystal device | E7 (wt %) | S811 (wt %) |
|---|---|---|---|
| 1 | (A) | 90 | 10 |
| 2 | (B) | 80 | 20 |
| 3 | (C) | 70 | 30 |
| 4 | (D) | 65 | 35 |
| 5 | (E) | 60 | 40 |

### Properties Measurement

### Example 6

### Reflectance Measurement of Liquid Crystal Device (V=0)

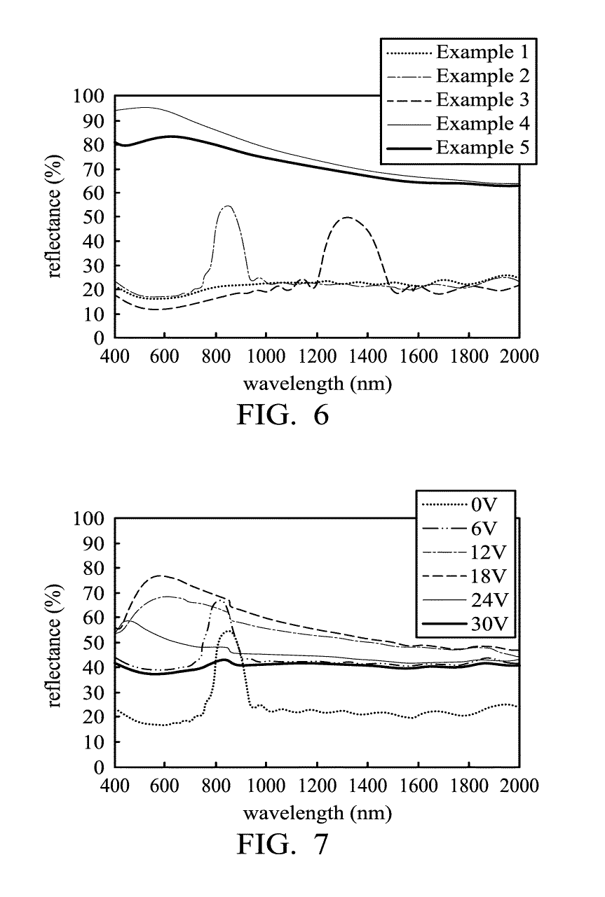

First, the transmission spectrum of an empty cell was measured by the spectrometer (type name V-670, manufactured b Jusco) as a reference point. Next, the transmission spectrums of the liquid crystal devices (A)-(E) were measured respectively by the spectrometer (type name V-670, manufactured b Jusco). Next, the obtained transmission spectrums were transferred into reflection spectrums (transmittance+reflectance+absorbance=1, the absorbance of the CLC was very low and ignored), and the results were shown in FIG. 6.

As shown in FIG. 6, the liquid crystal devices with different E7/S811 weight ratios exhibited different reflectance in the wavelength range of 400-2000 nm. The liquid crystal device (A) of Example 1 (S811 10 wt %) had a low reflectance over the wavelength range of 400-2000 nm. The liquid crystal devices (B) (S811 20 wt %) and (C) (S811 30 wt %) had a high reflectance in the infrared spectral region (compared with visible spectral region). The liquid crystal devices (D) (S811 35 wt %) and (E) (S811 40 wt %) had a high reflectance over the wavelength range of 400-2000 nm.

Accordingly, the liquid crystal device of the invention exhibited higher reflectance proportional to the weight percentage of the chiral compound. Further, since the liquid crystal devices (B) and (C) had higher reflectance in the infrared spectral region and exhibited high transparence, the liquid crystal devices (B) and (C) met the smart window requirements of the invention. Due to reflectance properties, the liquid crystal devices (B) and (C) were used in experimental tests, measuring values thereof after being applied various supply voltages to evaluate optoelectronic properties thereof.

### Example 7

### Reflectance Measurement of Liquid Crystal Device (B)

First, the liquid crystal device (B) of Example 2 was coupled to a power supply for supply voltage. Next, the transmission spectrums of the liquid crystal device (B) were measured using supply voltages from 0 to 30 volts. Next, the obtained transmission spectrums were transferred into reflection spectrums, wherein the results are shown in FIG. 7. Further, during applying a supply voltage from 0 to 30 volts to the liquid crystal device (B), the measured currents of the liquid crystal device (B) were smaller than the detection sensitivity of the milliampere meter. It means that the power consumption of the liquid crystal device (B) is less than 0.3 mW, thereby achieving power saving.

As shown in FIG. 7, the maximum reflective wavelength of the liquid crystal device (B) shifted to shorter wavelengths with increasing supply voltage. For supply voltages of between 0 to 6 volts, the maximum reflective wavelength of the liquid crystal device (B) was between 700 nm and 900 nm (i.e. infrared radiation). For supply voltages of between 12 to 18 volts, the maximum reflective wavelength of the liquid crystal device (B) fell within the visible spectrum. For supply voltages of between 24 to 30 volts, the liquid crystal device (B) had a reflectance of 40% over the visible and infrared spectral region. Further, the entire reflectance (over the visible and infrared spectral region) of the liquid crystal device (B) increased as supply voltages of between 0 and 12 volts increased. The liquid crystal device (B) had a maximum entire reflectance when a supply voltage of 18 volts was applied thereto. The liquid crystal device (B) had an entire reflectance of 40% when a supply voltages of between 24 to 30 volts was applied thereto.

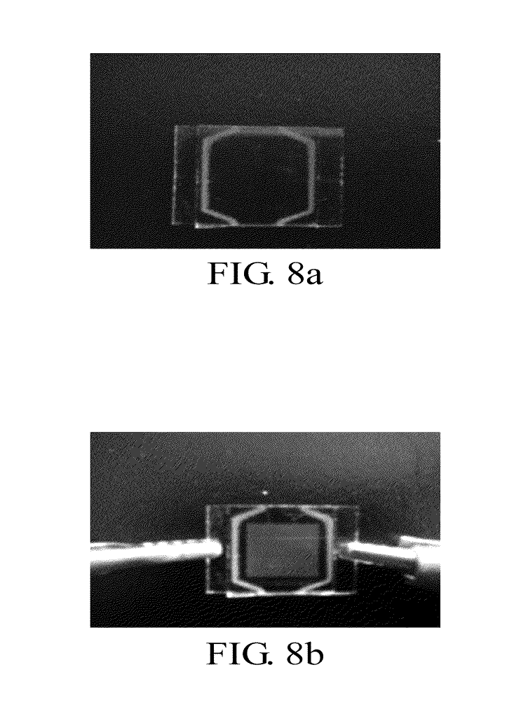

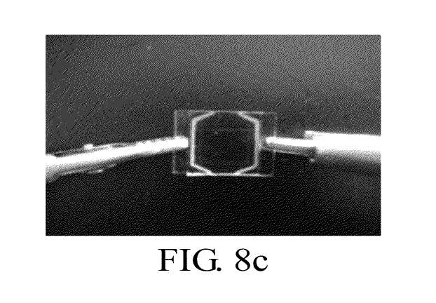

The infrared light and visible light transmittance of the liquid crystal device (B) applied with a supply voltage of 0V, 6V, 18V, and 30V are listed in Table 2. When applying a supply voltage of 0V or 6V, the liquid crystal device (B) exhibited the first transparent state, as FIG. 8a shows. Herein, the liquid crystal device (B) had a high visible light transmittance and a low infrared light transmittance of 45%. When applying a supply voltage of 18V, the liquid crystal device (B) exhibited the scattering state, as FIG. 8b shows. Herein, the liquid crystal device (B) had both reduced infrared light and visible light transmittances (less than 30%), thereby blocking the incident visible light and infrared light as a light shielding device.

When applying a supply voltage of 30V, the liquid crystal device (B) exhibited the second transparent state, as shown in FIG. 8c. Herein, the liquid crystal device (B) had increased infrared light and visible light transmittances (more than 60%), thereby allowing both infrared and visible light to transmit thereto; a condition of which, may be desired during the winter months.

TABLE 2

| | | infrared | visible | |
|---|---|---|---|---|
| | | light | light | |
| | | transmittance | transmittance | |
| | voltage | (%) | (%) | |
| | (V) | (700-900 nm) | (400-700 nm) | effectiveness |
| first | 0 | 45 | 80 | transmitting |
| transparent | 6 | 30 | 60 | visible light |
| state | | | | and blocking |
| | | | | infrared light |
| scattering | 18 | 30 | 25 | providing |
| state | | | | light shielding |
| | | | | means |
| second | 30 | 60 | 60 | increased |
| transparent | | | | infrared and |
| state | | | | visible light |
| | | | | transmittance |

### Example 8

### Reflectance Measurement of Liquid Crystal Device (C)

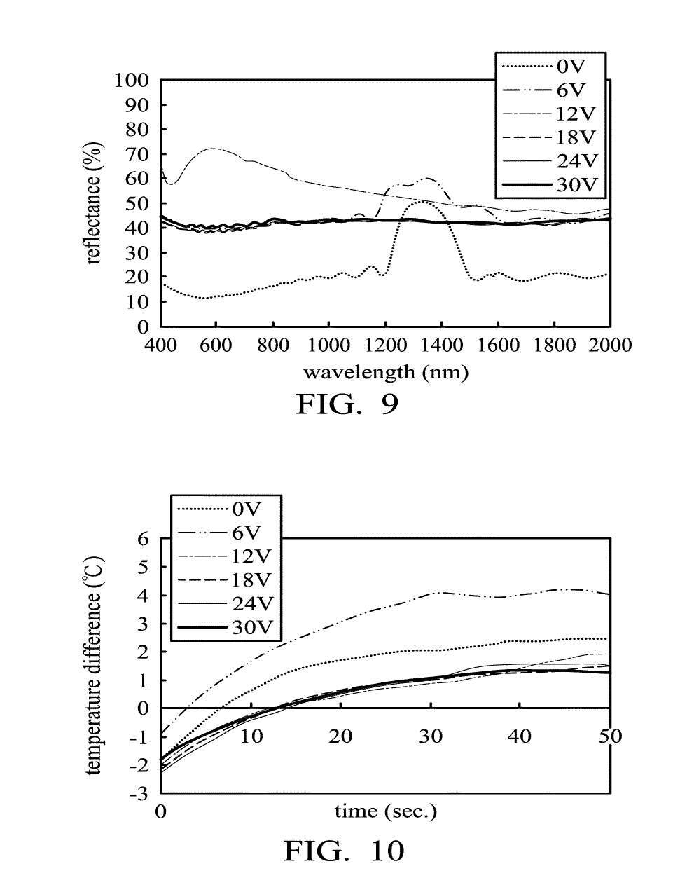

First, the liquid crystal device (C) of Example 3 was coupled to a power supply for supply voltage. Next, the transmission spectrums of the liquid crystal device (C) were measured at supply voltages from 0 to 30 volts. Next, the obtained transmission spectrums were transferred into reflection spectrums, and the results are shown in FIG. 9. Further, during applying a supply voltage from 0 to 30 volts to the liquid crystal device (C), the measured currents of the liquid crystal device (C) were smaller than the detection sensitivity of the milliampere meter. It means that the power consumption of the liquid crystal device (C) was less than 0.3 mW, thereby achieving power saving.

As shown in FIG. 9, the maximum reflective wavelength of the liquid crystal device (C) shifts to shorter wavelengths with supply voltage is increased.

For supply voltages of between 0 to 6 volts, the maximum reflective wavelength of the liquid crystal device (C) was between 1200 nm and 1500 nm (i.e. infrared radiation). For supply voltage of 12 volts, the maximum reflective wavelength of the liquid crystal device (C) fell within the visible spectrum. For supply voltages of between 18 to 30 volts, the liquid crystal device (B) had a reflectance of 40% over the visible and infrared spectral region. Further, the entire reflectance (over the visible and infrared spectral region) of the liquid crystal device (C) increased when supply voltages of between 0 and 12 volts increased. The liquid crystal device (C) had a maximum entire reflectance when a supply voltage of 12 volts was applied thereto. The liquid crystal device (C) had an entire reflectance of 40% when a supply voltages of between 18 to 30 volts was applied thereto.

The infrared light and visible light transmittance of the liquid crystal device (C) applied with a supply voltage of 0V, 6V, 12V, and 30V are listed in Table 2. When applying a supply voltage of 0V or 6V, the liquid crystal device (C) exhibited the first transparent state, and the liquid crystal device (C) had a high visible light transmittance and a low infrared light transmittance. When applying a supply voltage of 12V, the liquid crystal device (C) exhibited the scattering state, and the liquid crystal device (C) had both reduced infrared light and visible light transmittances (less than 40%), thereby blocking the incident visible light and infrared light like a light shielding device. When applying a supply voltage of 30V, the liquid crystal device (C) exhibited the second transparent state, and the liquid crystal device (C) had both increased infrared light and visible light transmittances (more than 60%), thereby allowing both infrared and visible light to transmit thereto; a condition of which, may be desired during the winter month.

TABLE 3

| | | infrared | visible | |
|---|---|---|---|---|
| | | light | light | |
| | | transmittance | transmittance | |
| | voltage | (%) | (%) | |
| | (V) | (1200-1500 nm) | (400-700 nm) | effectiveness |
| first | 0 | 50 | 80 | transmitting |
| transparent | 6 | 40 | 60 | visible light |
| state | | | | and blocking |
| | | | | infrared light |
| scattering | 12 | 40 | 30 | providing |
| state | | | | light |
| | | | | shielding |
| | | | | means |
| second | 30 | 60 | 60 | increased |
| transparent | | | | infrared and |
| state | | | | visible light |
| | | | | transmittance |

### Example 9

### Measurement of Response Time

The response time of the liquid crystal devices (B) and (C) were measured, and the results are shown in Table 4. The Response time was defined as the time that a cholesteric liquid crystal sample needs to change from 10% of the maximum dynamics range to 90% of the maximum dynamics range.

TABLE 4

| | |
|---|---|
| liquid crystal device (B) | liquid crystal device (C) |

| voltage | | voltage | |
|---|---|---|---|
| (V) | response time (S) | (V) | response time (S) |
| 12 | 0.381 | 9 | 0.006 |
| 14 | 0.204 | 10 | 0.005 |
| 18 | 0.112 | 11 | 0.005 |
| 20 | 0.1 | 12 | 0.004 |

As shown in Table 4, response time for the liquid crystal device decreased as supply voltage increased. Further, the liquid crystal device (B) (with 20 wt % chiral compound (S811)) exhibited a maximum response time of 0.1 s and the liquid crystal device (C) (with 30 wt % chiral compound (S811)) exhibited a maximum response time of 0.04 s. Accordingly, the response time of the liquid crystal devices were fast enough for use in the liquid crystal device of the invention.

### Example 10

### Measurement of Thermal Insulation

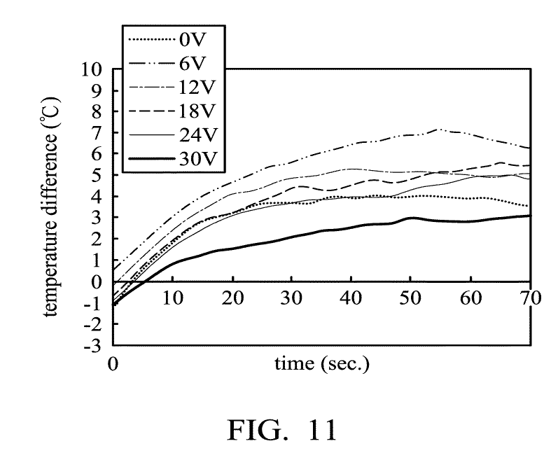

The thermal insulation ability of the liquid crystal device of the invention was measured by the following steps. First, the liquid crystal devices (B) and (C) were disposed within an opening of a thermal insulating box respectively, and a thermal sensor was disposed in the thermal insulating box. Next, the temperature difference between inside and outside of the thermal insulating box was measured after tuning of a halogen lamp (as a thermal source). The results of the measurements are shown in FIGS. 10 and 11. The temperature difference was gradually increased with time. Further, there is a largest temperature difference when a supply voltage of 6V is applied to the liquid crystal device.

Accordingly, due to the specific bistable liquid crystal composition of the invention, the liquid crystal device employing the same can exhibit sufficient transparency, reflecting (blocking) infrared light without applying a supply voltage (first transparent state), thereby providing thermal insulation. When applying a supply voltage to the liquid crystal device of the invention from 0V to a first critical voltage, the liquid crystal device switched to a scattering state can reflect (block) visible and infrared light simultaneously. Note that the liquid crystal devices of the invention with different liquid crystal compositions (different components) can be stacked together for use, such as composite smart windows of buildings or windshields of transportation vehicles

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A liquid crystal device, comprising:
a first substrate and a second substrate, wherein the first substrate and the second substrate are disposed parallel to each other;
a spacer formed between the first substrate and the second substrate to define a cavity; and
a cholesteric liquid crystal disposed in the cavity,
wherein the liquid crystal device is coupled to a supply voltage, and the liquid crystal device has a first transparent state, a second transparent state, and a scattering state which are switchable by adjusting the supply voltage magnitude.

2. The liquid crystal device as claimed in claim 1, wherein the first substrate has a first electrode and the second substrate has a second electrode, and the first and second electrodes are arranged opposite to each other.

3. The liquid crystal device as claimed in claim 1, wherein the cholesteric liquid crystal comprises a nematic liquid crystal and a chiral compound.

4. The liquid crystal device as claimed in claim 3, wherein the weight ratio between the nematic liquid crystal and the chiral compound is from 8:2 to 7:3.

5. The liquid crystal device as claimed in claim 3, wherein the nematic liquid crystal comprises 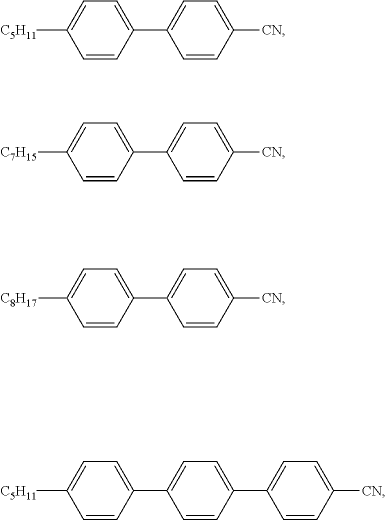
or combinations thereof.

6. The liquid crystal device as claimed in claim 1, wherein the chiral compound is

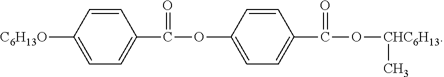

7. The liquid crystal device as claimed in claim 1, wherein the liquid crystal device exhibits the first transparent state when the supply voltage is not more than 6V.

8. The liquid crystal device as claimed in claim 1, wherein the first transparent state means that the liquid crystal device will reflect infrared light, but transmit visible light.

9. The liquid crystal device as claimed in claim 1, wherein the liquid crystal device exhibits the scattering state when the supply voltage reaches a first critical voltage value, and the liquid crystal device exhibits the second transparent state when the supply voltage reaches a second critical voltage value.

10. The liquid crystal device as claimed in claim 1, wherein the scattering state means that the liquid crystal device will reflect infrared light and visible light simultaneously.

11. The liquid crystal device as claimed in claim 1, wherein the second transparent state means that the liquid crystal device will transmit infrared light and visible light simultaneously.

12. The liquid crystal device as claimed in claim 9, wherein the second critical voltage is larger than the first critical voltage.

13. The liquid crystal device as claimed in claim 1, wherein the liquid crystal device is a smart window.
